(19) United States
(12) Patent Application Publication
(10) Pub. No.: US 2024/0082759 A1
(43) Pub. Date: Mar. 14, 2024

(54) DEVICE FOR REMOVING FOREIGN MATTER FROM A LIQUID

(71) Applicant: VITO AG, Tuttlingen (DE)

(72) Inventor: Andreas Schmidt, Tuttlingen (DE)

(73) Assignee: VITO AG, Tuttlingen (DE)

(21) Appl. No.: 18/269,419

(22) PCT Filed: Dec. 23, 2021
(86) PCT No.: PCT/EP2021/087452

§ 371 Date: Jun. 23, 2023

(30) Foreign Application Priority Data
Dec. 23, 2020 (DE) 10 2020 134 844.4

(51) Int. Cl. B01D 35/26; A47J 37/12; B01D 29/07; B01D 29/52; B01D 29/96

(52) U.S. Cl. CPC B01D 35/26; A47J 37/1223; B01D 29/07; B01D 29/52; B01D 29/96; B01D 2201/4007; F01M 11/03

(57) ABSTRACT

Device for removing foreign matter from a liquid by means of at least one filter, wherein the liquid with the foreign matter is fed from a bath to the filter by means of a rotor (34) via a shaft or an extension (40) in a housing (9), wherein an inlet (22) extends columnar vertically over at least a major part of a rear wall (21) of the housing (9) opposite to the filter.

### BACKGROUND OF THE INVENTION

The invention relates to a device for removing foreign substances from a liquid by means of at least one filter, wherein the liquid with the foreign matter is fed from a bath to the filter by means of an inlet in a housing.

There are a large number of liquids in the private and industrial sectors that need to be cleaned. These include, for example, cooling or lubricating baths in machine tools or also cooking oils, e.g. from deep fryers. These are only a few examples, but the invention is intended to cover all possible liquids to be cleaned.

As a rule, the liquid is taken from a storage tank from time to time and fed to a device for cleaning this liquid. From there, the liquid is then returned to the storage tank. Often, only the surface of the liquid is suctioned off so that the light materials that float up are removed. The heavy contaminant particles are then removed downward from time to time after they have settled.

The predecessor of the present invention is the EP 1 326 692 B1, in which the rotor is equipped with blades for sucking the liquid through recesses in the rotor disc and for pushing the liquid further into the shaft. In this case, an antechamber is to be formed in the filter housing between the shaft and the filter, and this filter housing is to be removably assigned to the immersion housing.

In practice, this device has proven to be excellent.

### SUMMARY OF THE INVENTION

The object of the present invention is to further improve the above-mentioned device and to increase its efficiency.

The solution to the object is that the inlet extends columnar vertically inside the housing over at least a major part of a rear wall of the housing opposite to the filter and has outlets on the front side and a chamber for returning the liquid to the bath is provided on at least one side wall of the housing, which is covered towards the interior of the housing by an internal filter.

On the one hand, this ensures that the entire cleaning unit consists only of a housing with corresponding filter inserts. In this respect, the entire unit can be kept much more compact.

Another significant advantage is that the inlet for the liquid to be cleaned is arranged as far away as possible from the ultra-fine filter, so that the liquid can be distributed throughout the entire housing. This improvement also makes it possible that the cleaned liquid does not only pass through the cleaning unit on one side, namely the front side opposite to the inlet, but can also be carried out laterally in each of the side walls. The liquid is forced by the rotor into the columnar inlet and leaves this columnar inlet through frontal outlets or lateral openings below the ceiling or, if necessary, an intermediate ceiling of the housing. In this way, a substantially improved vertical distribution of the liquid in the housing takes place.

Preferably, however, the cleaning of the liquid should also carried out at further points of the housing, in particular at the side walls. For this purpose, according to the invention, chambers are formed on the side walls of the housing, which are preceded by an internal filter through which the liquid must flow into the chamber, from which it is returned to the bath. It is preferably within the scope of the invention that these internal filters are designed to be removable from the housing, so that it is possible to vary the filter openings depending on the liquid to be cleaned. If coarse filtration is desired, the filter openings are larger than for fine filtration.

Preferably, the internal filter consists of a thin metal plate in which these filter openings are molded. Furthermore, further receptacles or holders for the textile filter are provided on one edge of the internal filter, which is then covered by a front cover connected to the housing.

To make it easier to replace the internal filter, the internal filter has engagement openings or handles for moving the internal filter. Preferably, the internal filter is guided in or on rails provided on the ceiling and/or the bottom of the housing. These rails run as close as possible along a vertical strip which projects inwards from the inside of the side wall of the housing. In this way, an almost closed chamber is formed which, in the position of use, is covered by the filter openings of the internal filter.

The above-mentioned ultra-fine filter is preferably made of a textile material and is already mentioned in the European patent application of the applicant described in the prior art.

In practice, it has been found that this possibility of multi-sided filtering of the liquid in the housing significantly increases the efficiency of the device.

This increase in efficiency is also served by a special design of the rotor with which the liquid is sucked in and introduced into the housing. Separate protection is also to be sought for this embodiment; of course, it has been found to be substantially useful especially in combination with the inventive idea described above. Here, the rotor is to be designed as a double rotor, in that a closed disc is located on the rotary shaft, which is connected via blades to a ring, through the opening of which the liquid enters the rotor. This double rotor makes it possible to force about ten times the amount of liquid per unit of time into the inlet and thus into the housing.

Overall, the rotor sits in a laminated core, which is covered at the bottom by an end plate that has an opening whose diameter is larger than the opening of the ring but smaller than the diameter of the ring. This sucks the liquid into the interior of the rotor.

The end plate is followed by a laminated core which forms a cylindrical recess in which the rotor rotates. However, this cylindrical recess is interrupted towards the above-mentioned inlet by an extension through which the liquid from the rotor enters the inlet. From there, it flows into the housing.

The new development is also characterized above all by improvements in the electrical unit or control unit. This includes, above all, the fact that the control unit can be connected wirelessly to an app, so that the entire device can also be controlled from this app. The app also records and stores all device data, such as in particular total run time, total cycle and maximum temperature. It also includes, in particular, the monitoring of a tilt angle of the device, wherein an anti-tip protection can also be activated and adjusted in view of the tilt angle. Similarly, it also includes a protection against forgetting the device in, for example, the deep fryer. However, these are only a few improvements in the control system.

### BRIEF DESCRIPTION OF THE DRAWINGS

Further advantages, features and details of the invention result from the following description of preferred embodiment and from the drawing; these show in

FIG. 1 a side view of a device according to the invention for removing foreign matter from a liquid;

FIG. 2 a front view of the device according to FIG. 1;

FIG. 3 a top view of the device according to FIG. 1;

FIG. 4 a perspective exploded view of the device according to FIG. 1;

FIG. 5 a perspective exploded view of a cleaning unit of the device according to FIG. 1;

FIG. 6 an exploded perspective view of parts of the cleaning unit rotated by about 90° compared to the view shown in FIG. 5;

FIG. 7 a perspective exploded view of a part of the cleaning unit of the device according to FIG. 1;

FIG. 8 a front view of the cleaning unit of the device according to FIG. 1 with the front cover removed;

FIG. 9 a cross-section through the cleaning part according to FIG. 7 along line VIII-VIII.

### DETAILED DESCRIPTION

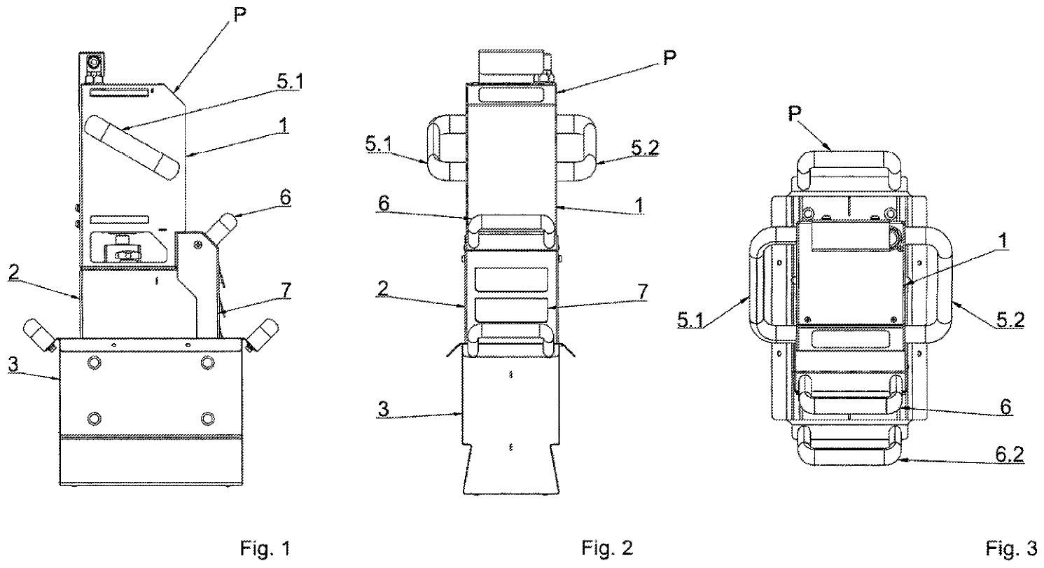

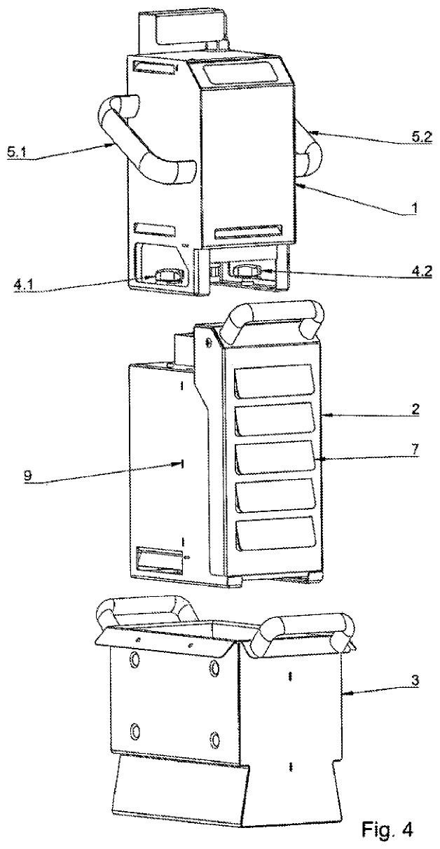

According to FIGS. 1 to 4, a device P according to the invention for removing foreign matter from a liquid has an electrical unit 1, a cleaning unit 2 and a collecting tray 3. The electrical unit 1 and the cleaning unit 2 are connected to each other by detachable fastening elements 4.1 and 4.2, for example corresponding screws. In the connected state of use, they form a portable unit by means of handles 5.1 and 5.2 and can be placed together in the collecting tray 3. When the cleaning unit 2 is separated from the electrical unit 1 by loosening the fastening elements 4.1 and 4.2, this cleaning unit 2 can be handled by means of another handle 6. Since the handle 6 is located on a front cover 7 which is connected to a housing 9 of the cleaning unit 2 by means of an hinge rod 8, this front cover 7 can also be rotated about the hinge rod 8 by means of the handle 6 and thus the interior of the housing 9 can be opened.

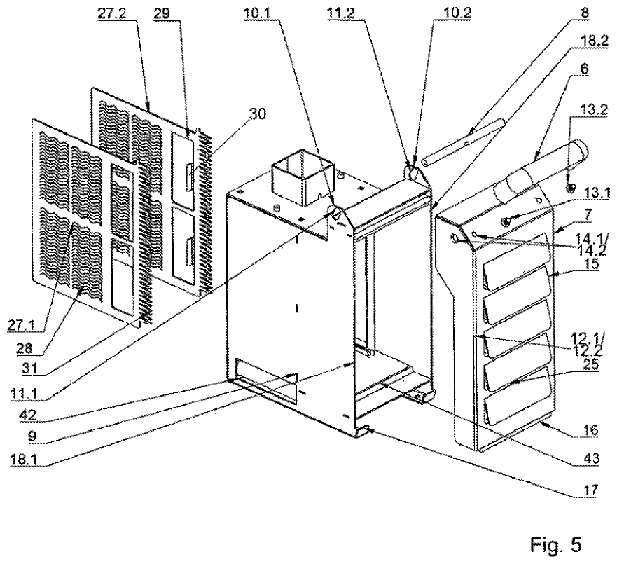

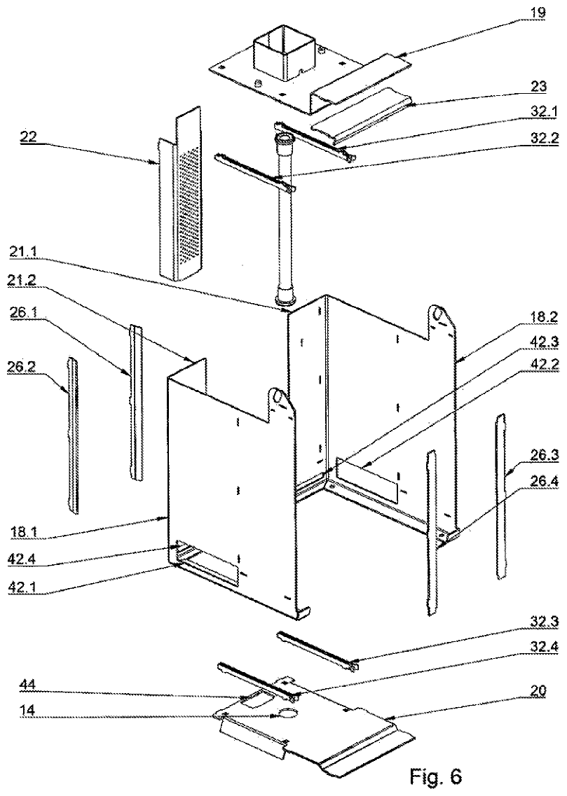

Since the present invention relates essentially to the cleaning unit 2, this is shown in more detail in FIGS. 5 to 9. The housing 9 to which the front cover 7 is hinged via the hinge rod 8 can be seen. For this purpose, the housing 9 has two elongated holes 11.1 and 11.2 in upwardly projecting lugs 10.1 and 10.2, between which the hinge rod 8 is inserted and over which the front cover 7 engages laterally with side walls 12.1 and 12.2, wherein corresponding screws 13.1 and 13.2 pass through holes 14.1 and 14.2 in the front cover 7 and engage in threaded holes in the hinge rod 8 which are not shown in greater detail.

At the front, a large number of holes are provided in the front cover 7 behind shielding plates 15, through which cleaned liquid can escape. Furthermore, the front cover 7 has a plug-in strip 16 in its lower area, with which the front cover 7 engages behind corresponding stops 17 on the housing 9 in the installed position, so that it closes off the housing 9. If it is to be opened, the front cover 7 is pulled upwards by the handle 6 so that the screws 13.1 and 13.2 slide upwards along the elongated holes 11.1 and 11.2 until the plug-in strip 16 disengages from the stop 17.

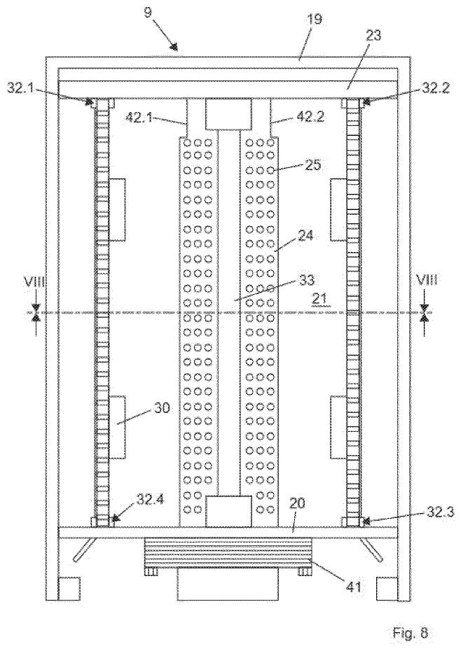

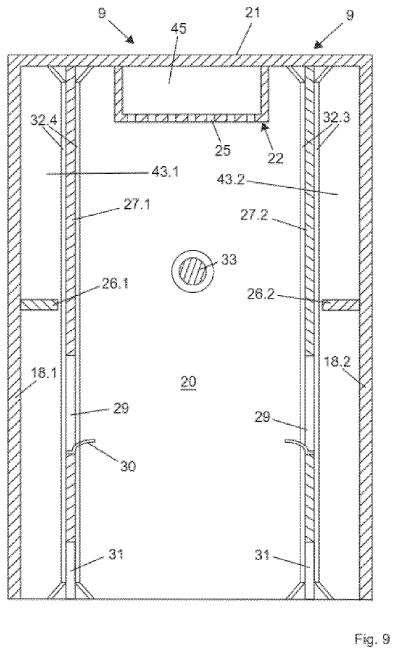

The housing 9 has two side walls 18.1 and 18.2, a ceiling 19, a bottom 20 and a rear wall 21. Inside the housing, according to FIGS. 8 and 9, there is a columnar inlet 22 extending from the bottom 20 to an intermediate ceiling 23 just below the ceiling 19. A plurality of outlets 25 are visible on its front side 24. Below the intermediate ceiling 23, unspecified side walls of the columnar inlet 22 leave larger lateral outlet openings 42.1 and 42.2. Encompassed by the inlet 22 and the rear wall 21 is a transfer opening 45 in the bottom 20, the connection of which will be described later.

Vertical strips 26.1 and 26.2 are provided approximately in the center of the housing 9, each projecting inwardly from the side walls 18.1 and 18.2, and together with a respective internal filter 27.1 and 27.2 form a chamber 43.1 and 43.2.

Each internal filter 27 is preferably made of a metal plate and has filter openings 28. In addition to the filter openings 28, the internal filter 27.1 or 27.2 has two engagement openings 29, in the area of which a handle 30 is provided in each case. At the front, the internal filter 27.1 or 27.2 is provided with prong-like receptacles or holders 31 for a textile filter described later.

In the housing 1, the internal filters 27.1 and 27.2 are guided in rails 32.1 to 32.4. Here, the rails 32.3 and 32.4 run along the bottom 20 to the rear wall 21, while the rails 32.1 and 32.2 are arranged correspondingly at the intermediate ceiling 23.

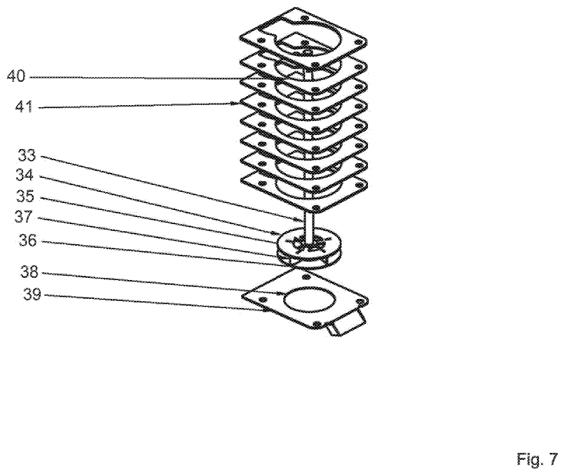

The housing 9 is also traversed by a rotary shaft 33, which serves to drive a rotor 34. This rotor 34 and its immediate surroundings are shown in FIG. 7. It can be seen that the rotor 34 consists of an upper disc 35 and an end ring 36, wherein disc 35 and ring 36 are connected to each other by blades 37. The ring 36 surrounds, not shown in FIG. 7, a larger opening corresponding to the opening 38 in an end plate 39. This opening in the ring 36 ensures that liquid to be cleaned can enter the rotor 34 up to the closed disc 35 between the blades 37, wherein the further conduction of the liquid then takes place into an extension 40 in a laminated core 41. The extension 40 forwards the liquid through the transfer opening 45 into the columnar inlet 22 on the rear wall 21 of the housing; wherein the bottom 20 of the housing 9 is broken open in the area of the extension 40 and the inlet 22.

The functioning of the present invention is as follows:

To remove foreign matter from a liquid, the device consisting of the electrical unit 1 and cleaning unit 2 is inserted into a corresponding liquid bath. Via the electrical unit 1, the rotary shaft 33 and thus the rotor 34 in the laminated core 41 are set in motion. This rotor 34 sucks in liquid containing foreign matter through the ring 36 supported by the blades 37 and forces this liquid into the extension 40 of the laminated core 41 and further through the transfer opening 45 into the columnar inlet 22. In practice, it has been found that this double rotor consisting of closed disc 35, open ring 36 and blade 37 can increase a suction capacity 10-fold.

The liquid then exits firstly from the outlets 25 and the lateral outlets 42.1 and 42.2 into the interior of the housing 9. This allows a very good and uniform distribution of the liquid over the height of the interior of the housing 9.

Furthermore, it should be emphasized that the liquid according to the present invention is very far away from the front filter in the front cover 7, held by the receptacles or holders 31 projecting from the internal filters 27.1 and 27.2, enters and can distribute itself evenly in the interior of the housing. This allows a much better distribution of the liquid to be cleaned in the entire interior of the housing 9.

In addition, the possibility is opened up of using not only the filter in the front cover 7 for cleaning, but also of providing other internals in the housing 9, which can serve for cleaning. For this purpose, the liquid flows through the filter openings 28 in the internal filters 27.1 and 27.2, is filtered there and then passes into the respective chamber 43.1 or 43.2, from where it then exits from lower openings 44 in the respective side walls 18.1 or 18.2 and returns to the bath.

An ultrafine filtering of the liquid is also performed by the textile filter in the front cover 7, which is not shown in more detail, wherein the cleaned liquid then exits through the openings covered by the shielding plate 15.

### REFERENCE SYMBOL LIST

| | |
|---|---|
| 1 | electrical unit |
| 2 | cleaning unit |
| 3 | collecting tray |
| 4 | fastening element |
| 5 | handle |
| 6 | handle |
| 7 | front cover |
| 8 | hinge rod |
| 9 | housing |
| 10 | lug |
| 11 | elongated hole |
| 12 | side wall |
| 13 | screw |
| 14 | hole |
| 15 | shielding plate |
| 16 | plug-in strip |
| 17 | stop |
| 18 | side wall |
| 19 | ceiling |
| 20 | bottom |
| 21 | rear wall |
| 22 | inlet |
| 23 | intermediate ceiling |
| 24 | front side |
| 25 | outlets |
| 26 | vertical strip |
| 27 | internal filter |
| 28 | filter opening |
| 29 | engagement opening |
| 30 | handle |
| 31 | holder |
| 32 | rail |
| 33 | rotary shaft |
| 34 | rotor |
| 35 | disc |
| 36 | ring |
| 37 | blade |
| 38 | opening |
| 39 | end plate |
| 40 | extension |
| 41 | laminated core |
| 42 | lateral outlet opening |
| 43 | chamber |
| 44 | from lower opening |
| 45 | transfer opening |

1. Device for removing foreign matter from a liquid by means of at least one filter, wherein the liquid with the foreign matter is fed from a bath to the filter by means of a rotor (34) via an inlet (22) in a housing (9), wherein
the inlet (22) extends columnar vertically inside the housing (9) over at least a major part of a rear wall (21) of the housing (9) opposite to the filter and has outlets (25) on the front side and a chamber (43.1,43.2) for returning the liquid to the bath, and is provided on at least one side wall (18.1,18.2) of the housing (9), which is covered towards the interior of the housing (9) by an internal filter (27.1,27.2).

2. Device according to claim 1, wherein the columnar inlet (22) has lateral outlets (42.1,42.2) in the upper area extending to a ceiling (19) of the housing (9).

3. Device according to claim 1, wherein the internal filter (27.1,27.2) consists of a metal plate in which filter openings (28) are formed.

4. Device according to claim 3, wherein the internal filter (27.1,27.2) has receptacles or holders (31) for the filter at its edge opposite the rear wall (21) of the housing (9).

5. Device according to claim 1, wherein the internal filter (27.1,27.2) has engagement openings (29) or handles (30) for moving the internal filter (27.1,27.2).

6. Device according to claim 1, wherein the internal filter (27.1,27.2) is removably inserted into the housing (9).

7. Device according to claim 6, wherein rails (32.1-32.4) for guiding the internal filter (27.1,27.2) are arranged on the ceiling (19 or 23) and/or the bottom (20) of the housing (9).

8. Device according to claim 7, wherein the rails (32.1-32.4) are arranged so close to the chamber (43.1,43.2) that it is covered by the inserted internal filter (27.1,27.2).

9. Device according to claim 1, wherein the filter is covered by a hinged front cover (7), wherein the front cover (7) has shielded outlets for the purified liquid.

10. Device according to claim 1, wherein the rotor (34) is designed as a double rotor, in which a closed disc (35) is seated on the rotary shaft (33) and is connected via radial blades (37) to a ring (36), through the opening of which the liquid enters the rotor (34).

11. Device according to claim 10, wherein radial projections project downwards from the ring.

12. Device according to claim 10, wherein the rotor is partially covered downwardly by an end plate (39) which has an opening (38) whose diameter is larger than the opening of the ring (36) but smaller than the diameter of the ring (36).

13. Device according to claim 12, wherein the end plate (39) is followed by a laminated core (41) which forms a cylindrical recess in which the rotor (34) rotates.

14. Device according to claim 13, wherein the cylindrical recess is interrupted towards the inlet (22) by an extension (40) through which the liquid passes from the rotor (34) into the inlet (22).

15-21. (canceled)
